(19) United States
(12) Patent Application Publication
(10) Pub. No.: US 2010/0117976 A1
(43) Pub. Date: May 13, 2010

(54) RESISTIVE TOUCH PANEL

(75) Inventors: HUNG-YI LIN, Taipei (TW); YUNG-LANG HUANG, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTeK COMPUTER INC., Taipei (TW)

(21) Appl. No.: 12/610,459

(22) Filed: Nov. 2, 2009

(30) Foreign Application Priority Data
Nov. 10, 2008 (TW) 097143405

(51) Int. Cl. G06F 3/041

(52) U.S. Cl. 345/173

(57) ABSTRACT

A resistive touch panel including a first-direction first electrode group and a first-direction second electrode group is provided. The first-direction first electrode group includes an electrode having N unit length. The first-direction second electrode group includes N electrodes each of which has one unit length. Two ends of multiple first-group strip-shaped layers are connected between the first-direction first electrode group and the first-direction second electrode group.

### FIELD OF THE INVENTION

The invention relates to a resistive touch panel and, more particularly, to a resistive touch panel which may detect multiple touch points simultaneously.

### BACKGROUND OF THE INVENTION

With the fast development of the computer technology, a touch panel is widely used in a mobile phone screen, a computer screen and a personal digital assistant (PDA) screen. Basically, the touch panel may replace a mouse to be a computer input device. In the touch panels nowadays, a resistive touch panel is most popular.

As shown in FIG. 1A, it is a side view showing a conventional resistive touch panel when it is not pressed. Multiple strip-shaped indium tin oxide (ITO) layers 102 are formed on the surface of a transparent glass substrate 100. In addition, multiple strip-shaped ITO layers 112 are formed on the surface of a transparent film 110. The strip-shaped ITO layers 102 on the transparent glass substrate 100 are perpendicular to the strip-shaped ITO layers 112 on the transparent film 110. In addition, multiple transparent spacer dots 120 isolate the strip-shaped ITO layers 102 on the transparent glass substrate 100 and the strip-shaped ITO layers 112 on the transparent film 110 to prevent them from contacting.

As shown in FIG. 1B, it is a side view showing the conventional resistive touch panel when it is pressed. When a touch control pen or a finger 130 presses the transparent film 110, the strip-shaped ITO layers 102 on the glass substrate and the strip-shaped ITO layers 112 on the transparent film 110 contact each other, and touch points are generated. Therefore, the control circuit (not shown) obtains a pressed position of the touch control pen or the finger 130 quickly.

As shown in FIG. 2, it is a top view showing the conventional resistive touch panel. For example, four electrodes are disposed around the touch panel 10. They are a negative Y (Y−) electrode, a positive Y (Y+) electrode, a negative X (X−) electrode and a positive X (X+) electrode. In addition, the strip-shaped ITO layers 102 on the glass substrate are arranged vertically, and the two ends of all the strip-shaped ITO layers are connected to the negative Y (Y−) electrode and positive Y (Y+) electrode. The strip-shaped ITO layers 112 on the transparent film 110 are arranged horizontally, and the two ends of all the strip-shaped ITO layers 112 are connected to the negative X (X−) electrode and the positive X (X+) electrode. All the strip-shaped ITO layers 102 and 112 may be equivalent to resistors.

In addition, the control circuit 150 is respectively connected to the negative Y (Y−) electrode, the positive Y (Y+) electrode, the negative X (X−) electrode and the positive X (X+) electrode via the Y− line, the Y+ line, the X− line and the X+ line. When touch points are generated by the user on the touch panel 10, the control circuit 150 may obtain the position of the touch point quickly.

As shown in FIG. 3A, it is a schematic diagram showing that whether touch points are generated on the conventional resistive touch panel is detected. In FIG. 3A to FIG. 3C, the transparent film 110 of the touch panel and the transparent glass substrate 100 are separated. First, to know about whether the user touches the touch panel, the control circuit (not shown) connects a power source (Vcc) to the positive X (X+) electrode, connects the ground end to the positive Y (Y+) electrode, connects the negative X (X−) electrode to the control circuit and open the negative Y (Y−) electrode.

Obviously, when the user does not press the touch panel, the upper strip-shaped ITO layers and the lower strip-shaped ITO layers do not contact each other. Therefore, the control circuit may receive the voltage of the Vcc at the negative X (X−) electrode. It represents that the user does not press the touch panel.

When the user presses the touch panel using a touch control pen 140, the upper strip-shaped ITO layers contact the lower strip-shaped ITO layers at the touch point A. Therefore, the control circuit detects that the negative X (X−) electrode receives a voltage

$$( \frac{R 3 \cdot Vcc}{R 1 + R 3} )$$

which is less than the voltage of the Vcc. That is, it is determined that the user presses the touch panel.

As shown in FIG. 3B, it is a schematic diagram showing the process of calculating the horizontal position of the touch point on the conventional resistive touch panel. To obtain the horizontal position of the touch point, when the control circuit detects the existence of the touch point A, it performs a switching process to connect a power source (Vcc) to the positive X (X+) electrode, connect the ground end to the negative X (X−) electrode, connect the positive Y (Y+) electrode to the control circuit and open the negative Y (Y−) electrode.

Obviously, the voltage on the positive Y (Y+) electrode is

$$Vx = \frac{R 2 \cdot V cc}{ R 1 + R 2} .$$

As shown in FIG. 3B, when the touch point A gets closer to the right side, the voltage Vx is higher, and on the contrary, when the touch point A gets closer to the left side, the voltage Vx is lower. Therefore, the control circuit may convert the voltage Vx via an analog to digital conversion to obtain the horizontal position of the touch point.

As shown in FIG. 3C, it is a schematic diagram showing the process of calculating the touch point on the conventional resistive touch panel. To obtain the vertical position of the touch point A, when the control circuit calculates the horizontal position of the touch point A, the control circuit performs the switching process again to connect a power source (Vcc) to the positive Y (Y+) electrode, connect the ground end to the negative Y (Y−) electrode, connect the positive X (X+) electrode to the control circuit and open the negative X (X−) electrode.

Obviously, the voltage at the positive X (X+) electrode is

$$Vy = \frac{R 4 \cdot Vcc}{R 3 + R 4}$$

As shown in FIG. 3C, when the touch point A gets closer to the upper side, the voltage Vy is higher, and on the contrary, when the touch point A gets closer to the lower side, the voltage Vy is lower. Therefore, the control circuit may convert the voltage Vy via an analog to digital conversion to obtain the vertical position of the touch point.

Since the conventional resistive touch panel is an analog touch panel, when multiple touch points are generated by a user in the touch panel simultaneously, the control circuit is unable to detect multiple touch points correctly, which may leads to wrong actions. For example, as shown in FIG. 4, it is a schematic diagram showing that multiple touch points are generated on the conventional resistive touch panel. When two touch points are generated simultaneously at the position A1 and the position A2 on the touch panel, supposing that the coordinate of the position A1 is (x1, y1), and the coordinate of the position A2 is (x2, y2), the control circuit not only is disable to detect the correct positions of the two touch points A1 and A2, but also may wrongly detect a third touch point A3. The coordinate of the position A3 is (x3, y3), wherein x3 equals to (x1+x2)/2, and y3 equals to (y1+y2)/2.

### SUMMARY OF THE INVENTION

The invention provides a resistive touch panel. When multiple touch points are generated on the resistive touch panel, the multiple touch points may be detected successively, and wrong detection may be prevented.

The invention provides a resistive touch panel including a first-direction first electrode group and a first-direction second electrode group. The first-direction first electrode group includes an electrode having N unit length, and the first-direction second electrode group includes N electrodes each of which has one unit length. Two ends of multiple first-group strip-shaped layers are connected to the first-direction first electrode group and the first-direction second electrode group.

### BRIEF DESCRIPTION OF THE DRAWINGS

These and other features, aspects and advantages of the present invention will become better understood with regard to the following description, appended claims, and accompanying drawings.

FIG. 1A is a side view showing the conventional resistive touch panel when it is not pressed;

FIG. 1B is a side view showing the conventional resistive touch panel when it is pressed;

FIG. 2 is a top view showing the conventional resistive touch panel;

FIG. 3A is a schematic diagram showing that whether touch points are generated on the conventional resistive touch panel is detected;

FIG. 3B is a schematic diagram showing the process of calculating the horizontal position of the touch point on the conventional resistive touch panel;

FIG. 3C is a schematic diagram showing the process of calculating the vertical position of the touch point on the conventional resistive touch panel;

FIG. 4 is a schematic diagram showing that multiple touch points are generated on the conventional resistive touch panel;

FIG. 5A is a schematic diagram showing the resistive touch panel in an embodiment of the invention;

FIG. 5B is a schematic diagram showing an equivalent circuit during the touch point detecting procedure;

FIG. 5C is a schematic diagram showing an equivalent circuit during a touch point verifying procedure;

FIG. 6A is a schematic diagram showing the divided area on the touch panel;

FIG. 6B is a schematic diagram showing that two touch points are generated on the touch panel simultaneously;

FIG. 6C is another schematic diagram showing that two touch points are generated on the touch panel simultaneously;

FIG. 7 is a flow path showing the method for detecting touch points in the resistive touch panel in an embodiment of the invention; and

FIG. 8 is a schematic diagram showing the electrode configuration in the four electrode groups on the touch panel.

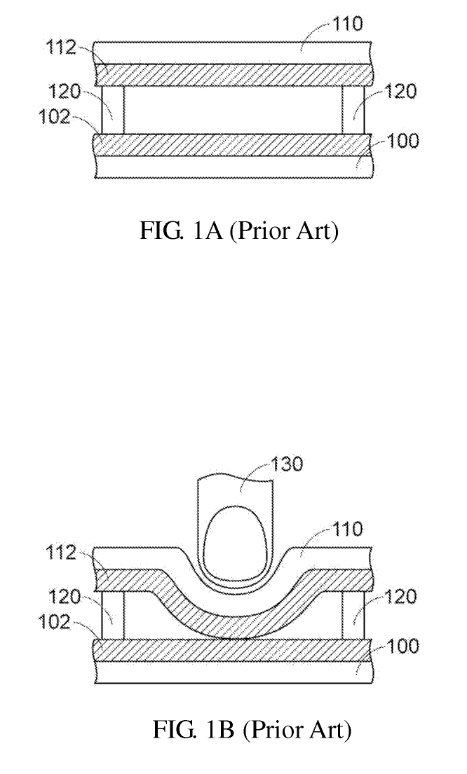

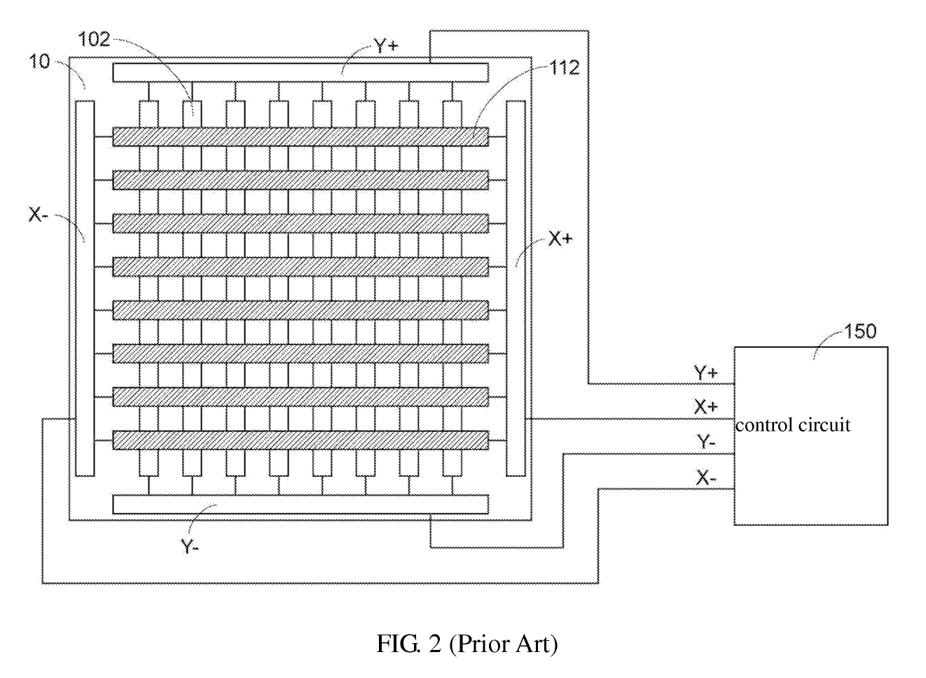

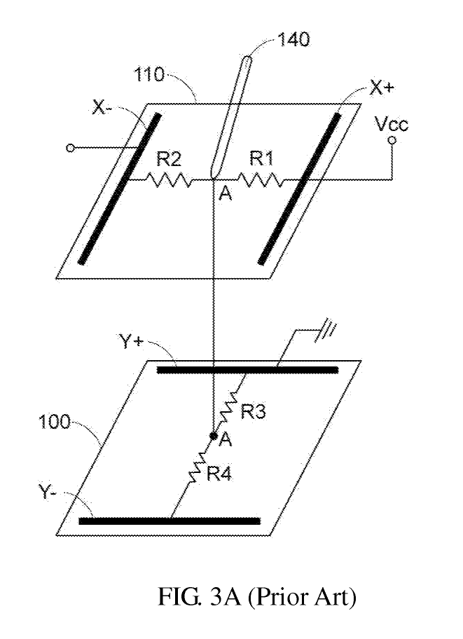

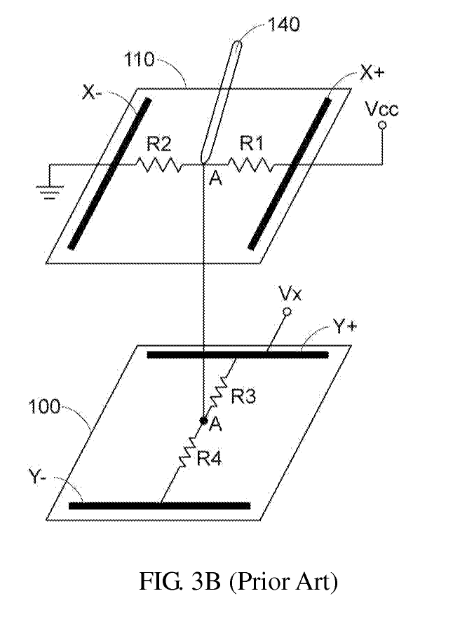

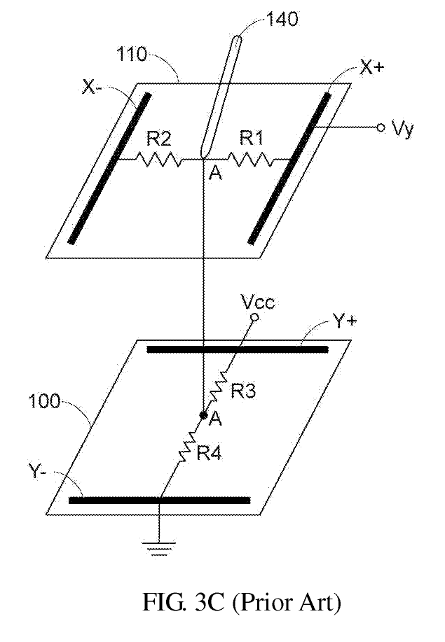

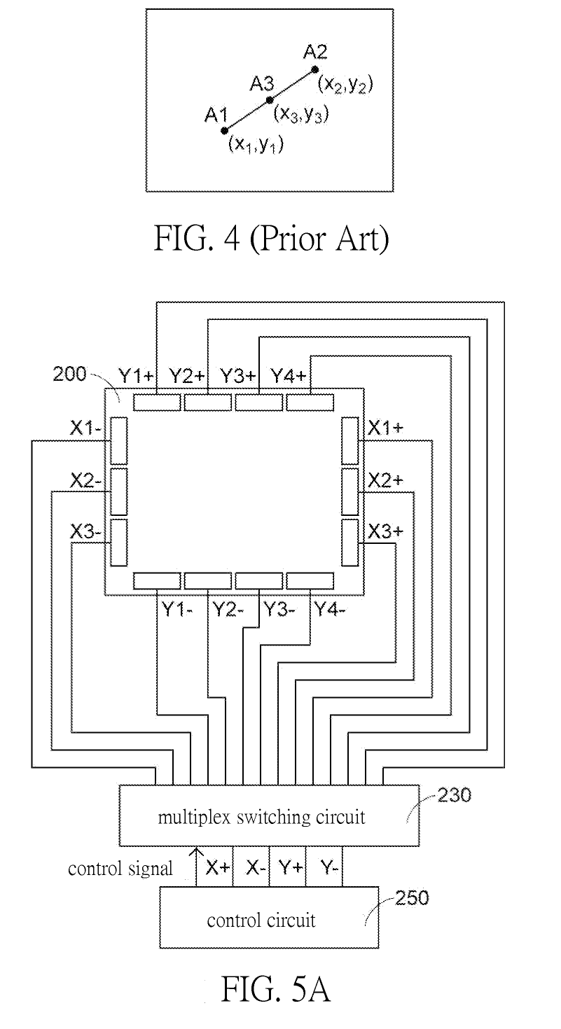

### DETAILED DESCRIPTION OF THE PREFERRED EMBODIMENT

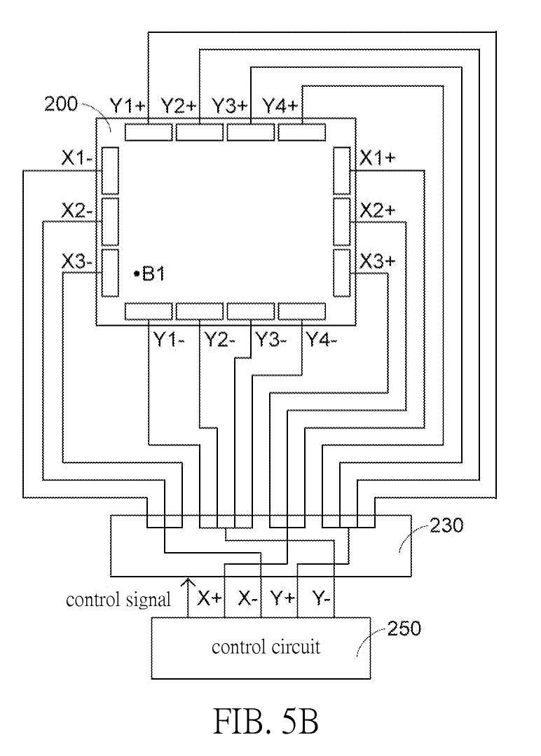

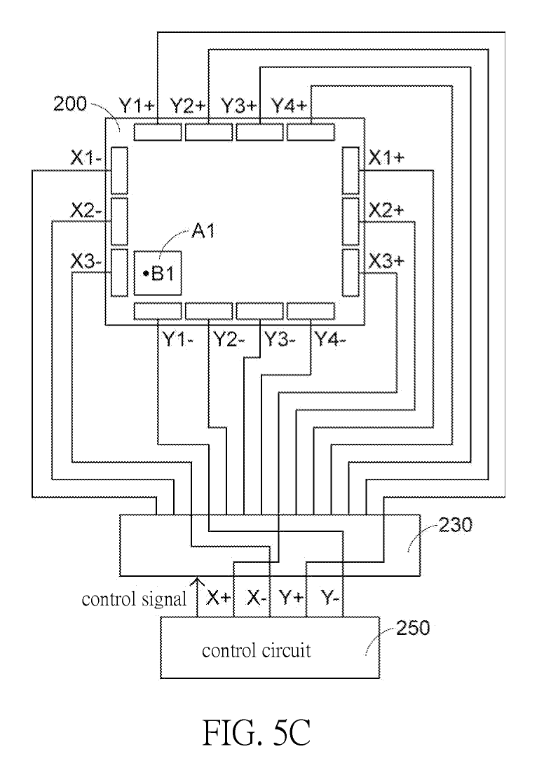

As shown in FIG. 5A, it is a schematic diagram showing the resistive touch panel in an embodiment of the invention. Four conventional electrodes (X+, X−, Y+, Y−) are divided in four groups of electrodes in the invention (X1+ to X3+, X1 to X3−, Y1+ to Y4+, Y1− to Y4−) to form the electrodes on the touch panel 200 in the embodiment of the invention. For example, three electrodes in a positive X (X+) group are a positive X1 (X1+) electrode, a positive X2 (X2+) electrode and a positive X3 (X3+) electrode; three electrodes in a negative X (X−) group are a negative X1 (X1−) electrode, a negative X2 (X2−) electrode and a negative X3 (X3−) electrode; three electrodes in a positive Y (Y+) group are a positive Y1 (Y1+) electrode, a positive Y2 (Y2+) electrode, a positive Y3 (Y3+) electrode and a positive Y4 (Y4+) electrode, and three electrodes in a negative Y (Y−) group are a negative Y1 (Y1−) electrode, a negative Y2 (Y2−) electrode, a negative Y3 (Y3−) electrode and a negative Y4 (Y4−) electrode.

For example, supposing there are 80 strip-shaped ITO layers in the vertical direction, 20 vertical ITO layers may be connected between the Y1+ electrode and the Y1− electrode. Others are by parity of reasoning Supposing that there are 30 strip-shaped ITO layers in the horizontal direction, 10 horizontal ITO layers may be connected between the X1+ electrode and the X1− electrode. Others are by parity of reasoning

The multiplex switching circuit 230 are connected to all electrodes, and it may selectively connect an X+ line to part or all electrodes in the X+ group, connect an X− line to part or all electrodes in the X− group, connect a Y+ line to part or all electrodes in the Y+ group and connect a Y− line to part or all electrodes in the Y− group.

The action of the touch panel in the embodiment of the invention is illustrated hereinbelow. First, as shown in FIG. 5B, it is a schematic diagram showing an equivalent circuit during the touch point detecting procedure. To detect whether a touch point is generated on the touch panel 200, the control circuit 250 connects the X+ line to all electrodes in the X+ group, connects the X− line to all electrodes in the X− group, connects the Y+ line to all electrodes in the Y+ group and connects the Y− line to all electrodes in the Y− group. In addition, the control circuit 230 performs the first switching action to connect a power source (Vcc) to the X+ line, connect the ground end to the Y+ line, take a signal of the X− line as a determining signal and open the Y− line. The control circuit 250 may detect all area of the touch panel if a touch point is generated.

For example, when a touch point is generated at the position B1 by the user, the control circuit 250 performs the second switching action to connect the power source (Vcc) to the X+ line, connect the ground end to the X− line, take the Vx signal of the Y+ line to determine the horizontal position of the touch point B1 and open the Y− line. Therefore, the Vx signal of the Y+ line is used to know the horizontal position of the touch point B1.

Then, the control circuit performs the third switching action to connect the power source (Vcc) to the Y+ line, connect the ground end to the Y− line, take the Vy signal of the X+ line to determine the vertical position of the touch point B1 and open the X− line. Therefore, the Vy signal of the X+ line is used to know the vertical position of the touch point B1.

As stated above, during the touch point detecting procedure, the control circuit 250 controls the multiplex switching circuit 230 to set all area of the touch panel 200 to be the detecting area. Thus, the vertical position and the horizontal position of the touch point B1 generated in any position can be detected.

Second, as shown in FIG. 5C, it is an equivalent circuit during a touch point verifying procedure. When the horizontal position and vertical position of the touch point B1 are calculated, the control circuit 250 knows that the touch point B1 is located at the area A1 composed of the Y1+, Y1−, X3+ and X3− electrodes. To confirm whether the touch point B1 is located in area A1, the control circuit 250 connects the X+ line to the X3+ electrode in the X+ group, connects the X− line to the X3− electrode in the X− group, connects the Y+ line to the Y1+ electrode in the Y+ group, and connects the Y− line to the Y1− electrode of the Y− group. In addition, the control circuit 230 performs the first switching action to connect a power source (Vcc) to the X+ line, connect the ground end to the Y+ line, take signal of the X− line as a determining signal and open the Y− line. The control circuit 250 may detect all area of the touch panel 200 to determine if the touch point B1 is generated.

When the control circuit 200 confirms that the touch point B1 exists in area A1, the control circuit 250 performs the second switching action to connect the power source (Vcc) to the X+ line, connect the ground end to the X− line, take the Vx signal of the Y+ line to determine the horizontal position of the touch point B1 and open the Y− line. Therefore, the Vx signal of the Y+ line is used to know the horizontal position of the touch point B1.

Then, the control circuit performs the third switching action to connect the power source (Vcc) to the Y+ line, connect the ground end to the Y− line, take the Vy signal of the X+ line to determine the vertical position of the touch point B1 and open the X− line. Therefore, the Vy signal of the X+ line is used to know the vertical position of the touch point B1.

Therefore, the control circuit 250 compares the obtained horizontal position and the vertical position of the touch point during the touch point detecting procedure with the obtained horizontal position and the vertical position of the touch point during the touch point verifying procedure. If the two touch points are determined to overlap each other, it represents that the single touch point B1 is generated by the user.

As stated above, during the touch point verifying procedure, the control circuit 250 controls the multiplex switching circuit 230 to reduce the detecting area and set it to be the area of the touch panel 200 which includes the touch point B1 and to make a confirmation. When the touch points B1 generated in two procedures overlap each other, it means that the single touch point B1 is generated by the user.

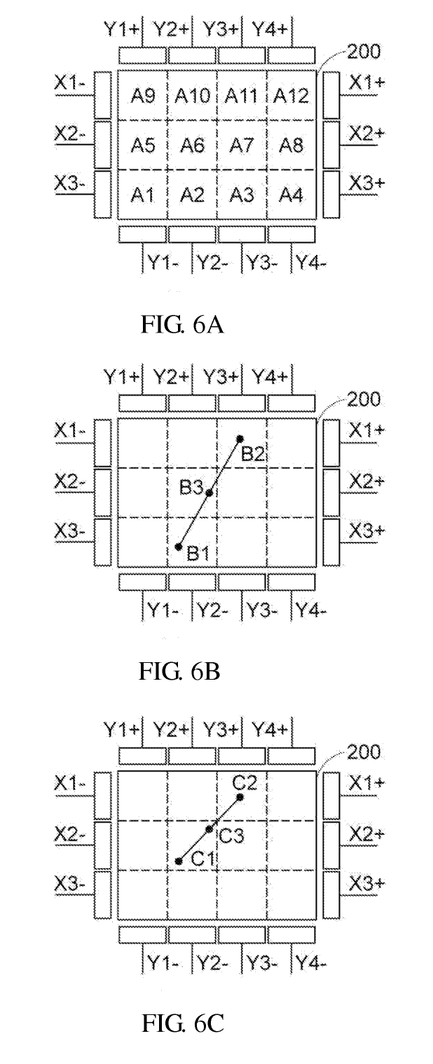

As shown in FIG. 6A, it is a schematic diagram showing the divided area on the touch panel. As shown in FIG. 6A, the control circuit 250 may control the multiplex switching circuit 230 to limit the touch panel 200 in any area of the area A1 to the area A12. The control circuit 250 also may control the multiplex switching circuit 230 to connect the X+ line to the X2+ and the X3+ electrodes in the X+ group, connect the X− line to the X2− and the X3− electrodes in the X− group, connect the Y+ line to the Y1+ electrode in the Y+ group, and connect the Y− line to the Y1− electrode of the Y− group. Therefore, the touch point may be limited in two areas of A1 and A5.

As shown in FIG. 6B, it is a schematic diagram showing that two touch points are generated on the touch panel simultaneously. When two touch points are generated at the position B1 and the position B2 on the touch panel simultaneously, supposing that the coordinate of the position B1 is (x1, y1), and the coordinate of the position B2 is (x2, y2), during the touch point detecting procedure, the control circuit 250 may wrongly detect a touch point B3. The horizontal coordinate of the touch point B3 is x3 which equals to (x1+x2)/2, and the vertical coordinate of the touch point B3 is y3 which equals to (y1+y2)/2.

Then, during the touch point verifying procedure, the control circuit 250 controls the multiplex switching circuit 230 to limit the detecting area in the area A6 and detect whether there are any touch point is in the area A6. Obviously, the control circuit 250 cannot detect any touch point overlapping the touch point B3 in area A6. Therefore, the control circuit 250 can confirm that multiple touch points are generated by the user.

When the control circuit 250 confirms that multiple touch points are generated by the user, the control circuit 250 controls the multiplex switching circuit 230 to change the detecting area in sequence and search the actual positions of the multiple touch points B1 and B2.

As shown in FIG. 6C, it is another schematic diagram showing that two touch points are generated in the touch panel simultaneously. When two touch points C1 and C2 are generated on the touch panel simultaneously, supposing that the coordinate of C1 is (x4, y4), and the coordinate of C2 is (x5, y5), the control circuit may wrongly detect a touch point C3 during the touch point detecting procedure. The horizontal coordinate x6 equals to (x4+x5)/2, and the vertical coordinate y6 equals to (y4+y5)/2.

Then, during the touch point verifying procedure, the control circuit 250 controls the multiplex switching circuit 230 to limit the detecting area in the area A6 and detect if there are any touch point in A6 area. Obviously, the control circuit 250 may detect the touch point C1 in the area A6, but the touch point C3 does not overlap. Therefore, the control circuit 250 can confirm that multiple touch points are generated by the user.

When the control circuit confirms that multiple touch points are generated by the user, the control circuit 250 controls the multiplex switching circuit 230 to change the detecting area in sequence and to find the actual position of another touch point C2.

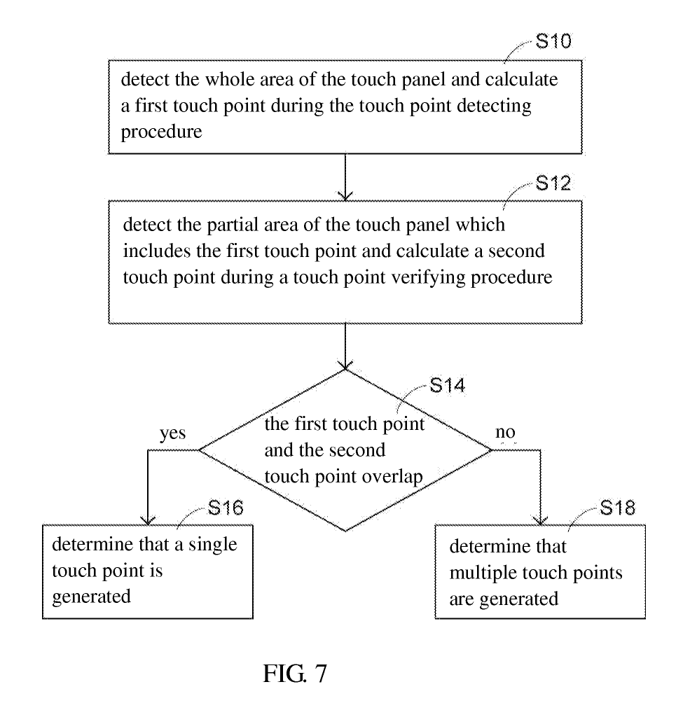

As shown in FIG. 7, it is a flow path showing the method for detecting touch points in the resistive touch panel in an embodiment of the invention. First, during the touch point detecting procedure, the whole area of the touch panel is detected and a first touch point position is calculated (Step S10). Then, during the touch point verifying procedure, the partial area of the touch panel including the first touch point position is detected, and a second touch point position is calculated (Step S12). When the first touch point position and the second touch point position overlap (step S14), it is confirmed that a single touch point is generated by the user (step S16). If not, it is confirmed that multiple touch points are generated by the user (step S18).

As stated above, in the resistive touch panel in the invention, whether a single touch point is generated by the user is detected, and if it is confirmed that the single touch point is generated, the horizontal position and vertical position thereof are provided. When the user generates multiple touch points, the control circuit may detect the multiple touch points generated by the user in small areas in sequence on the touch panel and provides horizontal positions and vertical positions of the multiple touch points.

In the invention, four electrode groups are disposed at four edges of the resistive touch panel, and every electrode group has multiple electrodes. As shown in FIG. 5A, the multiplex switching circuit needs 14 connecting lines to be connected to 14 electrodes and to divide the touch panel into 12 (three multiplied by four) minimum areas. That is, assuming that the four electrode groups are divided into two X− direction electrode groups and two Y− direction electrode groups, wherein each X− direction electrode group includes N electrodes, and each Y− direction electrode group includes M electrodes, the multiple switching circuit needs (2N+2M) connecting lines to be connected to (2N+2M) electrodes, and the touch panel is divided into (N multiplied by M) minimum areas.

The configuring mode of the four electrode groups in the resistive touch panel of the invention is illustrated hereinbelow. Using the configuring mode, the number of the connecting lines of the multiplex switching circuit is less, and the touch panel is divided into minimum areas with the same quantity.

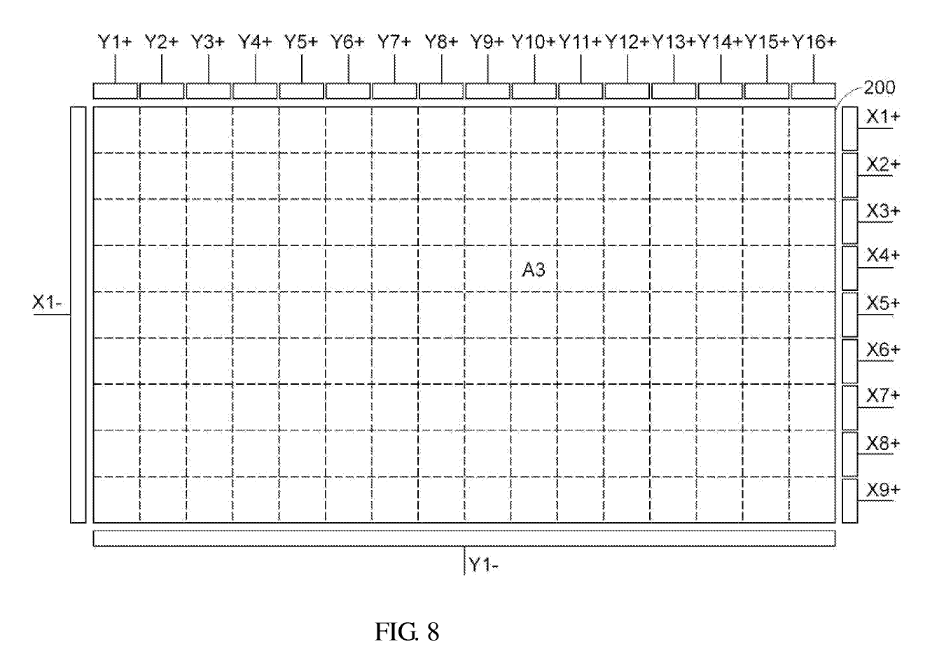

As shown in FIG. 8, it is a schematic diagram showing the configuration of the electrodes in the four electrode groups. To take the two X− direction electrode groups as an example, the X− direction electrode group only has an X1− electrode having nine unit length, and the X+ direction electrode group has multiple electrodes X1+ to X9+ each of which has one unit length. Thus, the two X− direction electrode groups may divide the horizontal area of the touch panel into nine areas.

In a similar way, to take the two Y− direction electrode groups as an example, the Y− direction electrode group only has an Y1− electrode having 16 unit length, and the Y+ direction electrode group has multiple electrodes Y1 to Y16 each of which has one unit length. Thus, the two Y− direction electrode groups may divide the horizontal area of the touch panel into 16 areas.

For example, the area composed of the Y10+ electrode, the Y1− electrode, the X4+ electrode and the X1− electrode may be defined as area A3. That is, when N equals to 9 and M equals to 16, the touch panel may be divided into (9 multiplied by 16) minimum areas, and only 27 (1+9+1+16) lines are needed.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A resistive touch panel comprising:
a first-direction first electrode group including an electrode having N unit length; and
a first-direction second electrode group including N electrodes each of which has one unit length;
wherein two ends of multiple first-group strip-shaped layers are connected to the first-direction first electrode group and the first-direction second electrode group, respectively.

2. The resistive touch panel according to claim 1, further comprising:
a second-direction first electrode group including an electrode having M unit length; and
a second-direction second electrode group including M electrodes each of which has one unit length;
wherein two ends of multiple second-group strip-shaped layers are connected to the second-direction first electrode group and the second-direction second electrode group.

3. The resistive touch panel according to claim 2, wherein the first direction and the second direction are perpendicular to each other.

4. The resistive touch panel according to claim 2 further comprising:
a multiplex switching circuit connected to all the electrodes; and
a control circuit controlling the multiplex switching circuit to selectively connect a first-direction first connecting line group to the first-direction first electrode group, connect a first-direction second connecting line group to part or all electrodes in the first-direction second electrode group, connect a second-direction first connecting line group to the second-direction first electrode group and connect a second-direction second connecting line group to part or all electrodes in the second-direction second electrode group.

5. The resistive touch panel according to claim 4, wherein during a touch point detecting procedure, the control circuit controls the multiplex switching circuit to connect the first-direction first connecting line group to the first-direction first electrode group, connect the first-direction second connecting line group to all electrodes in the first-direction second electrode group, connect the second-direction first connecting line group to the second-direction first electrode group, connect the second-direction second connecting line group to all electrodes in the second-direction second electrode group and determines a first touch point position.

6. The resistive touch panel according to claim 5, wherein during a touch point verifying procedure, the control circuit determines a first portion touch panel area, and the first touch point position is included in the first portion touch panel area.

7. The resistive touch panel according to claim 6, wherein during the touch point verifying procedure, the control circuit determines the first portion touch panel area, and the control circuit controls the multiplex switching circuit to connect the first-direction first connecting line group to the first-direction first electrode group, connect the first-direction second connecting line group to part of the electrodes in the first-direction second electrode group, connect the second-direction first connecting line group to the second-direction first electrode group, connect the second-direction second connecting line group to part of the electrodes in the second-direction second electrode group and determines a second touch point position.

8. The resistive touch panel according to claim 7, wherein when the first touch point position and the second touch point position overlap, it is confirmed that a single touch point is generated by a user, and when the first touch point position and the second touch point position do not overlap, it is confirmed that multiple touch points are generated by the user.

9. The resistive touch panel according to claim 2, wherein each of the first-group strip-shaped layer and second-group strip-shaped layer is composed of an indium tin oxide (ITO) layer.
